(19) United States
(12) Patent Application Publication
(10) Pub. No.: US 2020/0257020 A1
(43) Pub. Date: Aug. 13, 2020

(54) METHOD FOR DETERMINING AT LEAST ONE METEOROLOGICAL VARIABLE FOR DESCRIBING A STATE OF ATMOSPHERIC WATER

(71) Applicants: UBIMET GmbH, Wien (AT); Technische Universität Graz, Graz (AT)

(72) Inventors: Manfred Spatzierer, Wien (AT); Franz Teschl, Hausmannstätten (AT)

(21) Appl. No.: 16/646,985

(22) PCT Filed: Sep. 13, 2018
(86) PCT No.: PCT/AT2018/060210

§ 371 Date: Mar. 12, 2020

(30) Foreign Application Priority Data
Sep. 13, 2017 (AT) A50767/2017

(51) Int. Cl. G01W 1/14; G01W 1/02; G01S 13/95; H04B 7/185; G06K 9/00

(52) U.S. Cl. CPC G01W 1/14; G01W 1/02; G06K 9/0063; H04B 7/18513; G01S 13/955

(57) ABSTRACT

The invention relates to a method of determining at least one meteorological quantity (iwvc, ilwc, rr) for describing a state of atmospheric water, in particular of water vapor (wv), condensed water (lw) and/or precipitation (r), comprising the following steps:
(a) providing meteorological input data (d1),
(b) step in which—for at least one state (wv, lw) of the atmospheric water—second data (d2) are calculated from the meteorological input data (d1), said second data (d2) representing a measure of the signal attenuation of signals transmitted though the atmosphere (A), said signal attenuation being caused by said at least one state (wv, lw),
(c) providing third data (d3), which represent a measure of the signal attenuation of signals caused by atmospheric water, wherein the third data (d3) are obtained from the measurement of signals (3) which have been transmitted through the atmosphere (A) between signal transmission devices (1,2), in particular between signal transmission devices on satellites (1) and terrestrial signal transmission devices (2),
(d) comparing the second data (d2) with the third data (d3), and
(e) step in which—for at least one further state (lw, r) of the atmospheric water, which preferably has not been taken into account in the calculation of step (b)—a meteorological quantity (ilwc, rr) for describing said at least one further state (lw, r) is calculated in dependence of the deviation between the second data (d2) and the third data (d3).

The invention relates to a method for determining at least one meteorological quantity for describing a state of atmospheric water, in particular of water vapor, condensed water and/or precipitation.

In the prior art, it is known to use signals that are transmitted between signal transmission devices and thereby pass through the atmosphere for describing the current weather or for forecasting the weather. These signals also include signals between satellites and terrestrial signal transmitters/receivers (e.g. location or communication signals). The signals used in this process, which usually lie in the frequency range between 1 GHz and 1000 GHz, are attenuated (damped) by the atmosphere. The signal attenuation caused by the atmosphere may be subtracted from the intensity ratio between the transmitted and the received signals after the parameters on the transmitter and receiver ends (such as the geometric orientation and the distance between the transmission/reception devices, etc.) have been corrected. The signal attenuation in the atmosphere is mainly caused by atmospheric water; however, air pollution, aerosols, and non-meteorological particles and objects may contribute as well.

Vice versa, it is also of interest to know the damping of the signals transmitted through the atmosphere which is to be expected during a particular weather situation. The signal attenuations caused by the individual states of the atmospheric water can be found, for example, in Recommendation ITU-R P.676-11 (for gases including water vapor), Recommendation ITUR P.840-6 (for cloud and fog water), and Recommendation ITU-R P.838-3 (for rain) of the International Telecommunication Union.

The disadvantage of the known methods for describing the weather situation with the aid of the signal attenuation data is that the meteorological quantities determined this way are very inaccurate and neither provide a sufficiently accurate picture of the current weather situation, nor do they serve as sufficiently accurate initial data for calculating a reliable weather forecast. This is due to the fact that the individual signal attenuations caused by the different states of water in the atmosphere—water vapor (gaseous water), condensed water (liquid water in clouds and fog), precipitation (rain, snow, hail)—linearly overlap, and the total signal attenuation does not contain any information as to which states contribute to the signal attenuation to what extent.

It has been the object of the present invention to overcome the disadvantages of the prior art and to provide a method by means of which—using signal attenuation data obtained from signal measurements—at least one meteorological quantity for describing a state of atmospheric water may be determined. The method is intended to allow qualitative and quantitative statements on the state of interest. A preferred embodiment of the method is intended to allow determining the precipitation rate, in particular the rain rate.

This object is achieved by a method mentioned at the beginning with the following steps:

(a) providing meteorological input data,

(b) step in which—for at least one state of the atmospheric water—second data are calculated from the meteorological input data, said second data representing a measure of the signal attenuation of signals transmitted though the atmosphere, said signal attenuation being caused by said at least one state,

(c) providing third data, which represent a measure of the signal attenuation of signals caused by atmospheric water, wherein the third data are obtained from the measurement of signals which have been transmitted through the atmosphere between signal transmission devices, in particular between signal transmission devices on satellites and terrestrial signal transmission devices and/or between terrestrial signal transmission devices,

(d) comparing the second with the third data, and

(e) step in which—for at least one further state of the atmospheric water, which preferably has not been taken into account in the calculation of step (b)—a meteorological quantity for describing said at least one further state is calculated in dependence of the deviation between the second data and the third data.

The invention is based on the fact that each state of atmospheric water contributes to the signal attenuation to an independent extent. Moreover, the invention is based on the fact that the knowledge of the simultaneous occurrence of these states allows gradually deriving the contributions of the individual states to the signal attenuation. In addition, it is assumed that water vapor is constantly present and that basically no precipitation occurs if no clouds are present.

In this regard, the meteorological quantity is determined in at least two stages. (1) First of all, the signal attenuation is calculated for at least one state and compared to the signal attenuation obtained from signal measurements. In this regard, the signal attenuation obtained from signal measurements contains the contributions of all states of atmospheric water that are present (along the signal path). (2) A deviation between the signal attenuation calculated (for the at least one state) and the signal attenuation obtained from signal measurements may now be used for calculating a meteorological quantity for one further state.

If the signal attenuation obtained from signal measurements is greater than the signal attenuation calculated (for the at least one state), the presence of one further state is assumed in order to be able to explain this deviation. A meteorological quantity describing this further state may now by calculated from said deviation.

If the signal attenuation obtained from signal measurements is less than the signal attenuation calculated (for the at least one state)—or equal to it—, it may be assumed that no further state is present. The corresponding meteorological quantity may then be assigned the value 0.

The starting point of the method according to the invention are the meteorological input data, from which a meteorological quantity for describing a state may be determined, in particular the water vapor density. It is now the aim to determine a quantity for one further state in step (e). For this purpose, the comparison according to step (d) is used.

According to the present application, water vapor refers to water in the gaseous state, condensed water refers to liquid water (or liquid water adhering to condensation nuclei) in clouds or fog (cloud or fog water), and precipitation refers to water falling onto the earth's surface in liquid or solid form.

The signal attenuation for individual states (according to step (b)) is preferably calculated according to the recommendations (in particular the respectively current recommendations) of the International Telecommunication Union (www.itu.int):
Recommendation ITU-R P.676-11, “Attenuation by atmospheric gases”, approved in 2016 Sep. 30 (for gases including water vapor),
Recommendation ITU-R P.840-6, “Attenuation due to clouds and fog”, approved in 2013 Sep. 30 (for cloud and fog water), and/or
Recommendation ITU-R P.838-3, “Specific attenuation model for rain for use in prediction methods”, approved in 2005 Mar. 8 (for rain).

These documents are therefore incorporated in this application by reference.

The invention allows making more accurate statements on the states of atmospheric water and thus assess the current weather situation more accurately. By means of the method according to the invention, determining the precipitation rate becomes particularly interesting and reliable if water vapor and condensed water in clouds were taken into account beforehand (i.e. in step (b)), or if the signal attenuation caused by water vapor and condensed water (second data) was subtracted from the (total) attenuation obtained from the signal measurements (third data).

The data (meteorological input data, second data, third data, water vapor related data, condensed water related data) and quantities described in this application may—even if they are used in the singular—be two- or three-dimensional and thus also contain multiple values. For example, the meteorological quantity calculated in step (e) may comprise the precipitation rates of an entire area. The data and quantities may therefore be present depending on the location (and also be edited as a raster data set).

The data to be compared in step (c) or—see below—step (b2) are of course data of the same type (especially with regard to the same signal frequency, the same signal propagation direction and the same unit, for example dB) or are accordingly edited for the comparison. Since the actual signal transmissions rarely occur in the exactly vertical direction, the elevation is to be taken into consideration in each case. Therefore, the signal attenuation may be converted (normalized) into a particular (preferably vertical) signal propagation direction. Such methods are known in the art and therefore do not need to be discussed in detail at this point.

One preferred embodiment is characterized in that the calculation of the second data in step (b) is performed for the state of water vapor, and the second data are a measure of the signal attenuation caused by water vapor. Taking into consideration the gaseous state as well increases the accuracy of the calculated meteorological quantity according to step (e) as its contribution to the signal attenuation is not taken into account in the calculation according to step (e).

One preferred embodiment is characterized in that the state for which a meteorological quantity is calculated in step (e) is condensed water in clouds and/or fog, wherein the meteorological quantity calculated in step (e) preferably is the condensed water content, preferably the integrated condensed water content, in clouds and/or fog. The calculation may, for example, be carried out by assuming clouds in a range between a cloud lower boundary and a cloud upper boundary, for example in a range where the (relative) humidity is 1 or exceeds a specified threshold value (e.g. where it is greater than 0.99). For this range, a particular condensed water content is assumed. Said content may be specified in accordance with empirical values and/or depending on a particular cloud type. Preferably, a (constant) value between 0.05 g/m³ and 0.5 g/m³, preferably approximately 0.1 g/m³, is assumed for the condensed water content in the cloud layer concerned.

Calculating a meteorological quantity may, for example, be carried out by integrating the condensed water content along the vertical through the cloud range, so that the integrated condensed water content (integrated liquid water content) is obtained as the quantity.

One preferred embodiment is characterized in that calculating the second data in step (b) is carried out for the states of water and condensed water in clouds and/or fog, and the second data are a measure of the signal attenuation caused by water vapor and condensed water in clouds and/or fog. Thus, in this embodiment, the contributions of water vapor and condensed water are no longer taken into account in the calculation of the further state (in particular precipitation).

One preferred embodiment is characterized in that the state for which a meteorological quantity is calculated in step (e) is precipitation, wherein the meteorological quantity calculated in step (e) preferably is the precipitation rate, in particular the rain rate.

One preferred embodiment is characterized in that the meteorological input data at least comprise values for the air temperature, the air pressure and/or the humidity at a certain level, preferably at the earth's surface. The meteorological input data are preferably based on measurements performed by weather stations. In this regard, from the values measured at different locations, a two- or multi-dimensional data structure may be created by interpolation or by applying meteorological models; in said data structure, values of a meteorological quantity are assigned to each of the location coordinates. The meteorological input data are preferably configured in such a way that a three-dimensional model atmosphere may be created from them in which each volume unit and/or each grid point is assigned at least one value of at least one meteorological quantity.

One preferred embodiment is characterized in that comparing the second data with the third data according to step (d) is carried out by calculating a difference or a ratio between the signal attenuation according to the second data and the signal attenuation according to the third data

and/or that

calculating the meteorological quantity according to step (e) is carried out based on the difference and/or the ratio between the signal attenuation according to the second data and the signal attenuation according to the third data.

One preferred embodiment is characterized in that the value 0 is assigned to the meteorological quantity according to step (e) if the signal attenuation according to the third data is less than the signal attenuation according to the second data. In this case, it is not necessary to assume that a further state is present in order to explain the signal attenuation obtained from signal measurements.

One preferred embodiment is characterized in that in step (b)

(b1) for the state of water vapor water vapor related data are calculated based on the meteorological input data, said water vapor related data representing a measure of the signal attenuation of signals transmitted through the atmosphere, said signal attenuation being caused by water vapor, and

(b2) said water vapor related data are compared with the third data, and,

(b3) if the signal attenuation according to the third data is greater than the signal attenuation according to the water vapor related data, condensed water related data are calculated, which represent a measure of the signal attenuation caused by condensed water in clouds and/or fog, wherein the second data represent a measure of signal attenuation of signals caused by water vapor and condensed water in clouds and/or fog.

In this embodiment, the contributions of the water vapor and the condensed water to the signal attenuation are taken into account in step (b). In this regard, first of all, the signal attenuation caused by water vapor is calculated, and, after comparison with the signal attenuation obtained from measurements, the signal attenuation caused by condensed water is calculated. Thus, the calculation is performed gradually, with a comparison being performed between the stages.

One preferred embodiment is characterized in that the calculation according to step (b) is carried out by means of an atmosphere model, which assigns at least one value of at least one meteorological quantity for describing a state of atmospheric water, preferably the water vapor density and/or the condensed water content, to each height segment and/or each volume unit and/or each (grid) point of a model atmosphere in dependence of the meteorological input data.

A variety of models for vertical layering of the atmosphere (atmosphere models) are known. They are of fundamentally different types and may, for example, represent adiabatic (dry-adiabatic or moist-adiabatic) layering or inversion (a partial increase in temperature with the height in a particular layer): in detail, such layering models may also differ as to how a value is assigned to each volume unit or each (grid) point of the model atmosphere based on meteorological input data. This may be carried out by means of analytical functions, numeric calculation rules, applying (linear) temperature and/or (exponential) pressure gradients (along the vertical), etc. This way, starting out from a temperature at the earth's surface and based on a layering model (e.g. an adiabatic model), the temperatures and atmospheric pressures at any height may be calculated. If the humidity at the earth's surface is known as well, the water vapor density at any height may also be calculated.

One preferred embodiment is characterized in that a signal attenuation is calculated from each of the values contained in the model atmosphere, wherein the second data are calculated by integration or summation of the values (e.g. the water vapor density or the condensed water content or attenuation values correlating therewith) along preferably vertical signal paths through the model atmosphere.

One preferred embodiment is characterized in that in the calculation of condensed water in clouds, a cloud upper boundary is taken into account, wherein the cloud upper boundary is preferably derived from satellite images.

One preferred embodiment is characterized in that the calculation of the rain rate is carried out according to the relation

$$rr = \sqrt[α]{\frac{γ}{k}} ,$$

with rr representing the rain rate, γ representing the difference between the signal attenuation according to the second data and the signal attenuation according to the third data, and α and k representing parameters, wherein α and k have preferably been selected in accordance with Recommendation ITU-R P.838-3.

One preferred embodiment is characterized in that calculations of at least one step, in particular according to step (b) and/or step (d) and/or step (e),

are carried out in dependence of signal frequency and/or signal polarization and/or in dependence of the elevation of the signal propagation direction,

and/or

are carried out for one or several signal frequency/ies, wherein the signal frequency/ies preferably lie between 5 GHz and 100 GHz, in particular between 10 GHz and 50 GHz,

and/or

are only carried out below a specified height boundary, preferably below 20,000 m, preferably below 10,000 m, particularly preferably below 7,500 m (above sea level). In one preferred embodiment, the calculations are carried out below a selected height level, which is located below the tropopause (which depends on the latitude).

The object is also achieved by means of an algorithm for determining at least one meteorological quantity for describing a state of atmospheric water, in particular of water vapor, condensed water and/or precipitation, wherein the algorithm comprises the steps of a method according to the invention.

The object is also achieved by means of a data processing system and/or a computer program product stored on a data carrier for determining at least one meteorological quantity for describing a state of atmospheric water, in particular of water vapor, condensed water and/or precipitation, wherein an algorithm according to the invention is stored in the data processing system and/or in the computer program product.

To provide better understanding of the invention, the invention is explained in more detail with the aid of the following figures.

The following is shown in a strongly simplified, schematic representation:

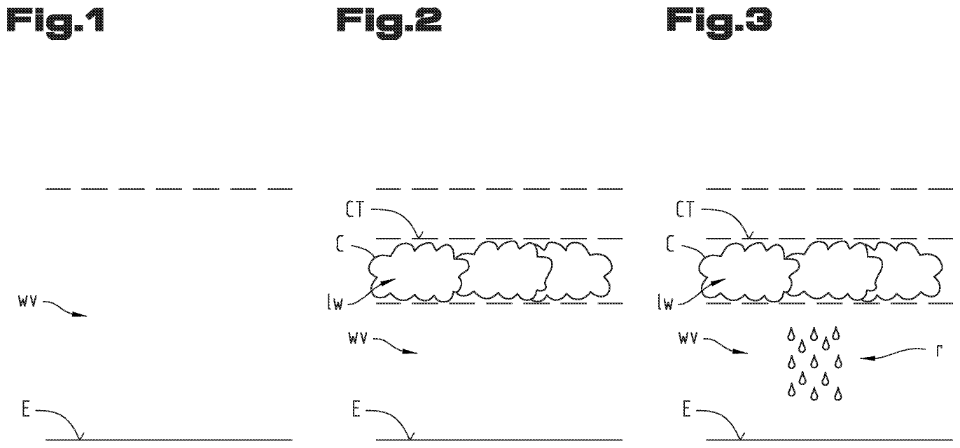

FIG. 1 an atmosphere which only contains water vapor;

FIG. 2 an atmosphere which only contains water vapor and condensed water (cloud water);

FIG. 3 an atmosphere which contains water vapor, condensed water (cloud water) and precipitation (rain);

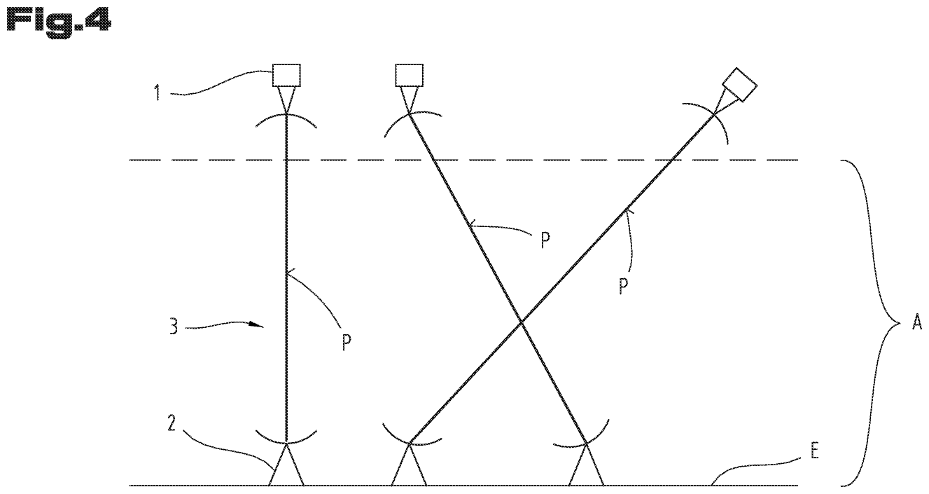

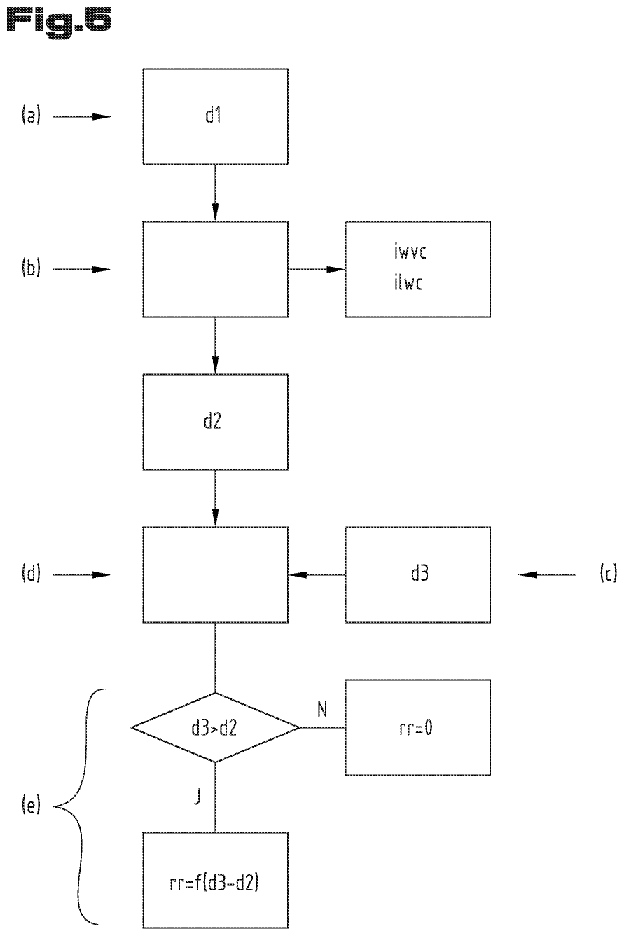

FIG. 4 a schematic representation of the signal transmission through the atmosphere between signal transmission devices on satellites and terrestrial signal transmission devices;

FIG. 5 a flow diagram for describing one embodiment of the invention;

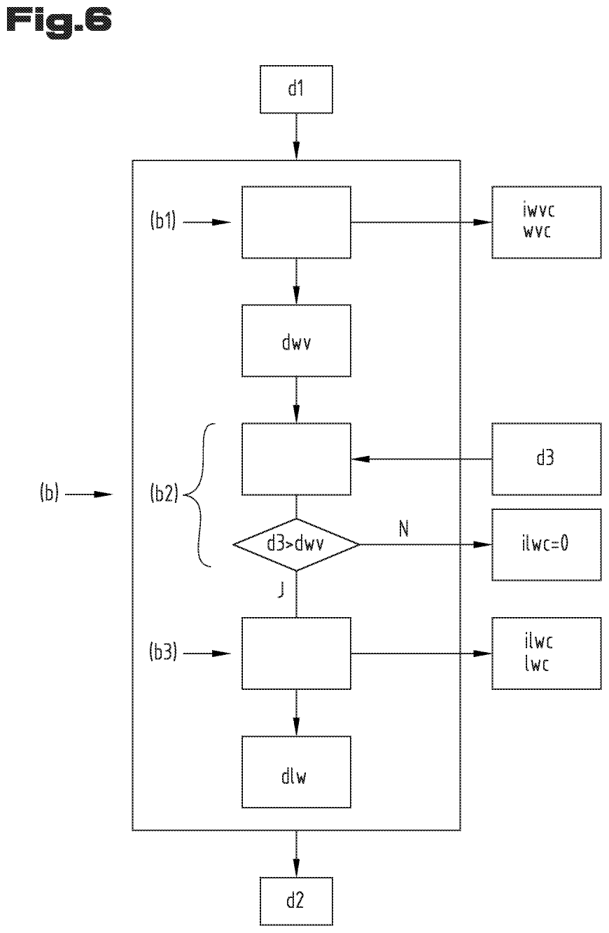

FIG. 6 a flow diagram for describing one embodiment of the invention;

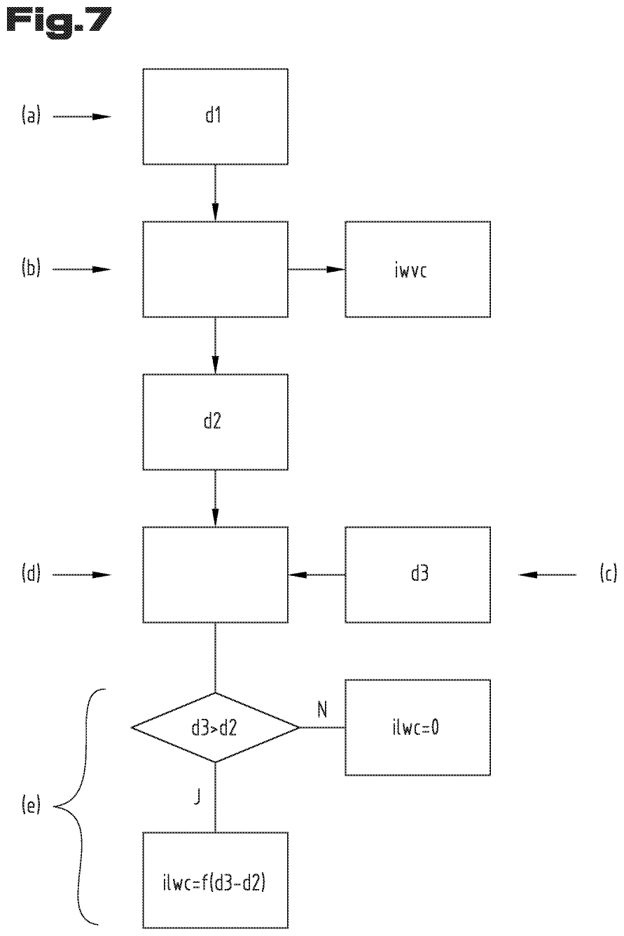

FIG. 7 a schematic representation of the signal attenuations caused by the individual states in the total attenuation;

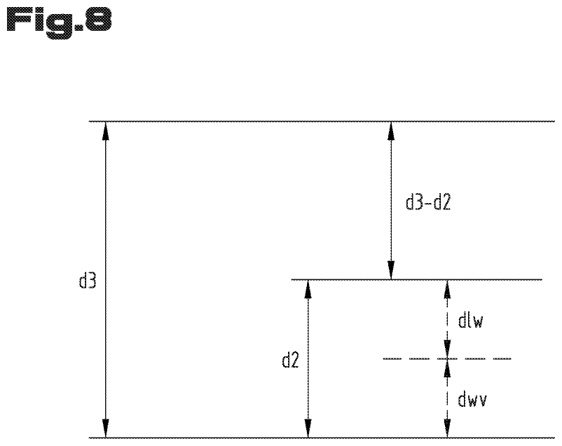

FIG. 8 the individual contributions to the signal attenuation.

As an introduction, it should be noted that in the embodiments described in different ways, identical parts or method steps are indicated with identical reference numbers or identical component designations; at the same time, the disclosures contained in the entire description may be analogously applied to identical parts with identical reference numbers or identical component designations. Moreover, the position indications chosen in the description, such as at the top, at the bottom, laterally, etc. refer to the figure which is directly represented and described; and if a position changes, said position indications are to be applied analogously to the new position.

The embodiments show possible variants; however, it should be noted at this point that the invention is not limited to the variants specifically shown; rather, various combinations of the individual variants are possible as well, and, due to the technical information provided by the present invention, this variation possibility is subject to the skills of the person skilled in the art who works in this technical field.

The scope of protection is determined by the claims. However, the description and the drawings are to be used for construing the claims. Individual features or feature combinations from the different embodiments that are shown and described may per se constitute independent solutions according to the invention. The object underlying the independent solutions according to the invention may be gathered from the description.

Any indications of value ranges in the present description are to be understood as including any and all subranges thereof; for example, the indication 1 to 10 is to be understood as including all subranges, starting out from the lower boundary 1 to the upper boundary 10; i.e. all subranges start with a lower boundary of 1 or greater and stop at an upper boundary of 10 or less, e.g. 1 to 1.7 or 3.2 to 8.1 or 5.5 to 10.

For the sake of good order, it should finally be noted that, for better understanding, some of the facts shown in the figures have been represented unscaled and/or enlarged and/or in reduced size.

FIGS. 1-3 show possible weather constellations that may be described with the method according to the invention. In FIG. 1, a part of an atmosphere A, the troposphere, is shown, where water is only present in the (invisible) state of water vapor wv. E refers to the earth's surface. Preferably, the calculations underlying the invention are only performed up to a specified upper boundary (uppermost dashed line). The boundary may be set in the range between 6,000 hm (from sea level) and the tropopause (which depends on the latitude), for example. This way, on the one hand, the range relevant for weather patterns is taken into consideration, and, on the other hand, the required arithmetic operations are kept at a manageable level. FIG. 2 shows a weather situation where clouds C and thus condensed water lw are present in addition to water vapor wv. The clouds C are located between a lower boundary and an upper boundary CT (cloud top). In FIG. 3, water is also present in the state of precipitation r (rain).

When signals 3 are transmitted along signal paths P between data transmission devices 1, 2 through the atmosphere A, the present states of atmospheric water cause a signal attenuation, which may be captured and provided in decibel, for example. The different elevations of the signal paths P (see FIG. 4) may be converted, so that the edited data, which represent a measure of the signal attenuation, only refer to one elevation, preferably to the vertical direction.

By means of FIG. 5, an embodiment of the method according to the invention is now described in detail. The object is to determine a meteorological quantity for describing a state of atmospheric water. As already mentioned, water is particularly present in the states of water vapor wv, condensed water lw (in clouds or fog) and/or precipitation r. Examples of meteorological quantities for such states include: water vapor density (water vapor content), integrated water vapor density iwvc, condensed water content (liquid water content) lwc, integrated condensed water content ilwc, precipitation rate (rain rate) rr.

The method now comprises the following steps:

(a) providing meteorological input data (d1). Said data preferably comprise values for the air temperature, the air pressure and/or the humidity at a particular level, preferably at the earth's surface E.

(b) a step in which, for the state(s) of water vapor wv and/or condensed water lw, second data d2 are calculated from the meteorological input data d1, said second data representing a measure of the signal attenuation of signals transmitted through the atmosphere A, said signal attenuation being caused by water vapor wv and/or condensed water lw. In this process, for example, a quantity describing the state—e.g. the water vapor density wvc (e.g. in the unit kg/m³) and/or the condensed water content lwc (e.g. in the unit kg/m³)—are calculated. From this quantity, the signal attenuation may then be derived. Further quantities, such as the integrated water vapor density iwvc (in the unit kg/m²) and/or the integrated condensed water content ilwc (in the unit kg/m²) may then be calculated as a “by-product”.

(c) providing third data d3, which represent a measure of the signal attenuation of signals caused by atmospheric water, wherein the third data d3 have been obtained from the measurement of signals 3 transmitted through the atmosphere A between signal transmission devices 1, 2, in particular between signal transmission devices on satellites 1 and terrestrial signal transmission devices 2 (see FIG. 4); additionally or alternatively, measurements of signals that were or are transmitted through the atmosphere A from terrestrial signal transmission devices to other terrestrial signal transmission devices may also be used for the third data d3.

(d) comparing the second data d2 with the third data d3. The data d2 and d3 may, for example, include the signal attenuation in the unit dB. Comparing the second data d2 with the third data d3 may be carried out by calculating a difference or a ratio between the signal attenuation according to the second data d2 and the signal attenuation according to the third data d3.

(e) step in which the precipitation rate rr is calculated for the state of precipitation r (said state has not been taken into account in the calculation according to step (b)) in dependence of the deviation between the second data d2 and the third data d3. The precipitation rate rr may be calculated from the difference and/or the ratio between the signal attenuation according to the second data d2 and the signal attenuation according to the third data d3. This means that the precipitation rate rr (in particular the rain rate) may, for example, be represented as a function of this difference: rr=f (d3−d2). The value 0 is assigned to the precipitation rate if the signal attenuation according to the third data d3 is less than the signal attenuation according to the second data d2.

By means of this method, it is ensured that the signal attenuation is not only assigned to the state calculated in step (e) (here: precipitation r), but that contributions of other states (here: water vapor wv and/or condensed water lw) as such are already taken into account beforehand.

If two states are already taken into account in step (b), step (b) may be carried out according to the preferred embodiment of FIG. 6. The remaining steps may then be carried out in the same way as FIG. 5, as described above.

According to FIG. 6, the following steps are carried out:

(b1) for the state of water vapor wv water vapor related data dwv are calculated based on meteorological input data d1, said water vapor related data representing a measure of the signal attenuation of signals transmitted through the atmosphere A, said signal attenuation being caused by water vapor (vw).

(b2) said water vapor related data dwv are compared with the third data d3. The third data d3 may be the same data that were already used in the method of FIG. 5.

(b3) if the signal attenuation according to the third data d3 is greater than the signal attenuation according to the water vapor related data dwv, condensed water related data dlw are calculated, which represent a measure of the signal attenuation caused by condensed water lw in clouds C and/or fog.

The second data d2 now represent a measure of the signal attenuation caused by water vapor wv and condensed water lw in clouds C and/or fog. In other words, the second data are the sum of the water vapor related data dwv and the condensed water related data dlw.

The second data d2 may then, as shown in FIG. 5, be used further. FIG. 7 shows another embodiment in which the calculation of the second data d2 in step (b) is (only) carried out for the state of water vapor wv. The second data d2 then represent a measure of the signal attenuation caused by water vapor wv. The state for which a meteorological quantity is calculated in step (e) is condensed water lw in clouds C and/or fog. In this regard, the meteorological quantity may be the condensed water content lwc in clouds C and/or fog, preferably the integrated condensed water content ilwc. Such a method is suitable, for example, if it is clear from other observations that no precipitation is present in the evaluated area.

FIG. 8 illustrates the contributions of the individual states of atmospheric water to the signal attenuation. The principle described above is based on the assumption that the contribution of water vapor dwv, the contribution of condensed water dlw and the contribution of precipitation dr=d3−d2 together result in the signal attenuation d3 obtained from measurements. It becomes apparent from this presentation that the method according to the invention has great advantages as not only the presence of a state may be determined, but, due to the gradual assignment with respect to the signal attenuation, precise quantitative statements on a state may be made as well.

Below, preferred embodiments are described with reference to the individual steps.

The calculation according to step (b) may be carried out by means of an atmosphere model which, in dependence of the meteorological input data d1, assigns at least one value of at least one meteorological quantity for describing a state wv, lw of atmospheric water, preferably the water vapor density and/or the condensed water content lwc, to each height segment and/or each volume unit and/or each point of a model atmosphere.

A variety of different atmosphere models are known. They are of fundamentally different types and may, for example, represent adiabatic (dry-adiabatic or moist-adiabatic) layering or inversion (a partial increase in temperature with the height in a particular layer). By means of mathematical relations, based on data obtained from measurements in the area of the earth's surface, such as air temperature, air pressure and humidity, a three-dimensional model may be created. A (linear) temperature gradient (e.g. in the unit K/m) may be assumed for the heightdependent temperature.

Calculating the water vapor density may be carried out by calculating the saturated vapor pressure at the given temperature and deriving the current vapor pressure from the saturated vapor pressure and the relative humidity. For converting the vapor pressure into water vapor density (e.g. in the unit kg/m³), the ideal gas equation of thermodynamics may be used.

Calculating the water vapor density is carried out, for example, by applying the August Roche Magnus formula for calculating saturated vapor pressure from the temperature, calculating the current vapor pressure from the relative humidity and the saturated vapor pressure, and applying the ideal gas equation for converting the vapor pressure into water vapor density.

In this case, the calculation is made up of the following formulas:

$${e}_{sat} = 610.94 exp ( \frac{17 .25 \cdot t}{t + 243.04} ) \\ e = {r}_{H} \cdot {e}_{s a t}$$

$$ρ = \frac{e}{{R}_{V} T} ,$$

with e designating the current vapor pressure in Pa, eₛₐₜ designating the saturated vapor pressure in Pa, t designating the temperature in ° C., T designating the temperature in K, r_{H} designating the relative humidity in %, ρ designating the water vapor density in kg/m³, and R_{V}=461.5 J/(kg K) designating the individual gas constant of water. In the method according to the invention, the water vapor density (which is also referred to as wvc in the present application) designated with ρ in the last formula may also be used for calculating the second data d2.

If the condensed water content lwc is to be calculated according to FIG. 6 as well, additional assumptions may be made, such as the cloud lower boundary and the cloud upper boundary, or they may be derived from additional measurements or (satellite) images. For example, the calculation according to step (b3) may be carried out in such a way that wherever (within the cloud lower boundary and the cloud upper boundary) the relative humidity is 1 or greater than a specified threshold value (e.g. >0.99), a (constant) value of the condensed water content is assumed. Preferably, in the cloud layer concerned, a (constant) value for the condensed water content between 0.05 g/m³ and 0.5 g/m³, preferably approximately 0.1 g/m³ is assumed. The signal attenuation may now in turn be calculated from the values that have been (analytically) calculated or assumed (based on empirical values) for the condensed water content.

This is preferably carried out by calculating the second data d2 by integration or summation along preferably vertical signal paths P (slant paths) through the model atmosphere.

The calculation of the rain rate rr is preferably carried out according to the relation

$$rr = \sqrt[α]{\frac{γ}{k}} ,$$

with γ representing the difference between the signal attenuation according to the second data d2 and the signal attenuation according to the third data d3, and α and k representing parameters. The latter have preferably been selected in accordance with Recommendation ITU-R P.838-3.

The calculations described above may be carried out in dependence of the signal frequency and/or signal polarization and/or in dependence of the elevation of the signal propagation direction. They may also be carried out for one or several signal frequency/ies, with the signal frequency/ies preferably lying between 5 GHz and 100 GHz, particularly between 10 GHz and 50 GHz.

As already mentioned, the calculations may be limited to areas below a specified height boundary, preferably below 20.000 m, preferably below 10.000 m, particularly preferably below 7.500 m (above sea level). Usually, the tropopause (which depends on the latitude) forms an uppermost boundary for the above calculations.

### LIST OF REFERENCE NUMBERS

1 signal transmission device on a satellite
2 terrestrial signal transmission device
3 signal
A atmosphere
C clouds
CT cloud upper boundary
E earth's surface
P signal path
wv water vapor
wvc water vapor density
iwvc integrated water vapor density
lw condensed water in clouds and/or fog
lwc condensed water content
ilwc integrated condensed water content
r precipitation
rr rain rate
d1 meteorological input data
d2 second data
d3 third data
dwv water vapor related data
dlw condensed water related data

1. A method for determining at least one meteorological quantity for describing a state of atmospheric water, in particular at least one of water vapor, condensed water or precipitation, comprising the following steps:
(a) providing meteorological input data,
(b) step in which—for at least one state of the atmospheric water—second data is calculated from the meteorological input data, said second data representing a measure of the signal attenuation of signals transmitted though the atmosphere (A), said signal attenuation being caused by said at least one state,
(c) providing third data, which represent a measure of the signal attenuation of signals caused by atmospheric water, wherein the third data is obtained from the measurement of signals which have been transmitted through the atmosphere between signal transmission devices, in particular between signal transmission devices on satellites and terrestrial signal transmission devices, or between terrestrial signal transmission devices, or both,
(d) comparing the second data with the third data, and
(e) step in which—for at least one further state of the atmospheric water—a meteorological quantity for describing said at least one further state is calculated in dependence of the deviation between the second data and the third data.

2. The method of claim 1, wherein the calculation of the second data in step (b) is carried out for the state of water vapor, and the second data represents a measure of the signal attenuation caused by water vapor.

3. The method of claim 1, wherein the state for which a meteorological quantity is calculated in step (e) is condensed water in clouds and/or fog.

4. The method according to claim 1, wherein the calculation of the second data in step (b) is carried out for the states of water vapor and condensed water in clouds and/or fog, and the second data represents a measure of the signal attenuation caused by water vapor and condensed water in clouds and/or fog.

5. The method according to claim 1, wherein the state for which a meteorological quantity is calculated in step (e) is precipitation, wherein preferably the meteorological quantity calculated in step (e) is the precipitation rate, in particular the rain rate.

6. The method according to claim 1, wherein the meteorological input data at least comprises values for the air temperature, the air pressure and/or the humidity at a particular level, preferably at the earth's surface.

7. The method according to claim 1, wherein comparing the second data with the third data according to step (d) is carried out by calculating a difference or a ratio between the signal attenuation according to the second data and the signal attenuation according to the third data.

8. The method according to claim 1, wherein the value 0 is assigned to the meteorological quantity according to step (e) if the signal attenuation according to the third data is less than the signal attenuation according to the second data.

9. The method according to claim 1, wherein step (b) further comprises:
(b1) for the state of water vapor, water vapor related data is calculated based on the meteorological input data, said water vapor related data representing a measure of the signal attenuation of signals transmitted through the atmosphere, said signal attenuation being caused by water vapor, and
(b2) said water vapor related data is compared with the third data, and
(b3) if the signal attenuation according to the third data is greater than the signal attenuation according to the water vapor related data, condensed water related data is calculated, which represents a measure of the signal attenuation caused by condensed water in clouds and/or fog,
wherein the second data represents a measure of the signal attenuation of signals caused by water vapor and condensed water in clouds and/or fog.

10. The method according to claim 1, wherein the calculation according to step (b) is carried out by means of an atmosphere model which assigns—in dependence of the meteorological input data at least one value of at least one meteorological quantity for describing a state of atmospheric water, preferably the water vapor density and/or the condensed water content, to each height segment and/or each volume unit and/or each point or grid point of a model atmosphere.

11. The method according to claim 10, wherein a signal attenuation is calculated from each of the values contained in the model atmosphere, wherein the second data is calculated by integration or summation along, preferably vertical, signal paths (P) through the model atmosphere.

12. The method according to claim 1, wherein a cloud upper boundary is taken into account in the calculation of condensed water in clouds, wherein preferably the cloud upper boundary is derived from satellite images.

13. The method according to claim 1, wherein the calculation of the rain rate is carried out according to the relation
$$rr = \sqrt[α]{\frac{γ}{k}} ,$$
with rr representing the rain rate, γ representing the difference between the signal attenuation according to the second data and the signal attenuation according to the third data, and α and k representing parameters, wherein preferably the parameters α and k have been selected in accordance with Recommendation ITU-R P.838-3.

14. The method according to claim 1, wherein the calculations of at least one of steps (b), (d), or (e) are performed according to one or more of the following:
in dependence of the signal frequency,
in dependence of the signal polarization,
in dependence of the elevation of the signal propagation direction,
for one or several signal frequency/ies, wherein preferably the signal frequency/ies lie between 5 GHz and 100 GHz, in particular between 10 GHz and 50 GHz, or
only below a specified height boundary, preferably below 20,000 m, particularly preferably below 10,000 m, even more preferably below 7,500 m.

15-16. (canceled)

17. The method according to claim 1, wherein the at least one further state of the atmospheric water, for which in step (e) a meteorological quantity for describing said at least one further state is calculated, has not been taken into account in the calculation of step (b).

18. The method of claim 1, wherein the meteorological quantity calculated in step (e) is the condensed water content in clouds and/or fog.

19. The method of claim 1, wherein the meteorological quantity calculated in step (e) is the integrated condensed water content in clouds and/or fog.

20. The method of claim 1, wherein calculating the meteorological quantity according to step (e) is carried out from the difference and/or the ratio between the signal attenuation according to the second data and the signal attenuation according to the third data.

21. A data processing system operable to perform the method of claim 1.

22. A computer program product stored on a non-transitory computer-readable medium, including instructions for performing the method of claim 1.
